(19) United States
(12) Patent Application Publication
(10) Pub. No.: US 2007/0276865 A1
(43) Pub. Date: Nov. 29, 2007

(54) ADMINISTERING INCOMPATIBLE CONTENT FOR RENDERING ON A DISPLAY SCREEN OF A PORTABLE MEDIA PLAYER

(76) Inventors: William K. Bodin, Austin, TX (US); David Jaramillo, Lake Worth, FL (US); Jesse W. Redman, Cedar Park, TX (US); Derral C. Thorson, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/420,015

(22) Filed: May 24, 2006

(51) Int. Cl. G06F 17/00

(52) U.S. Cl. 707/104.1

(57) ABSTRACT

Methods, systems, and computer program products are provided for administering incompatible content for rendering on a display screen of a portable media player. Embodiments include selecting content for visual display on a display screen of a portable media player, the content being in a data format incompatible with the portable media player; creating a plurality of image files including the content, the image files being in a data format compatible with the portable media player; and storing the plurality of image files as a playlist. Embodiments also typically include storing the playlist on the portable media player and displaying the plurality of images of the playlist on the display screen of the portable media player.

### BACKGROUND OF THE INVENTION

1. Field of the Invention

The field of the invention is data processing, or, more specifically, methods, systems, and products for administering incompatible content for rendering on a display screen of a portable media player.

2. Description Of Related Art

Many conventional portable media players include display screens for displaying metadata associated with the media files supported by the portable media players. Such portable media players are often lightweight and portable making the portable media players user friendly. Despite the fact that the portable media players are lightweight, portable, and include display screens, such digital media players often support limited file formats.

### SUMMARY OF THE INVENTION

Methods, systems, and computer program products are provided for administering incompatible content for rendering on a display screen of a portable media player. Embodiments include selecting content for visual display on a display screen of a portable media player, the content being in a data format incompatible with the portable media player; creating a plurality of image files including the content, the image files being in a data format compatible with the portable media player; and storing the plurality of image files as a playlist. Embodiments also typically include storing the playlist on the portable media player and displaying the plurality of images of the playlist on the display screen of the portable media player.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for administering incompatible content for rendering on a display screen of a portable media player according to embodiments of the present invention.

FIG. 2 sets forth a block diagram depicting a system for administering incompatible content for rendering on a display screen of a portable media player (108) according to the present invention.

FIG. 3 sets forth a block diagram of automated computing machinery comprising an exemplary consolidated content management server useful in administering incompatible content for rendering on a display screen of a portable media player according to embodiments of the present invention.

FIG. 4 sets forth a block diagram of automated computing machinery comprising an exemplary computer useful in administering incompatible content for rendering on a display screen of a portable media player according to the present invention.

FIG. 5 sets forth a flow chart illustrating an exemplary computer computer-implemented method for administering content for rendering on a display screen of a portable media player.

FIG. 6 sets forth a method of selecting content in a word processing document for visual display on a display screen of a portable media player and creating a plurality of image files that contains the content.

FIG. 7 sets forth a flow chart illustrating an exemplary method for selecting content in a presentation for visual display on a display screen of a portable media player and creating a plurality of image files containing the content.

FIG. 8 sets forth a flow chart illustrating an exemplary method for selecting content in a markup document for visual display on a display screen of a portable media player and creating an image file containing the content of the markup document.

FIG. 9 sets forth a line drawing of an exemplary content selection screen useful in receiving from a user an identification of content for visual display on a display screen of a portable media player according to the present invention.

### DETAILED DESCRIPTION OF EXEMPLARY EMBODIMENTS

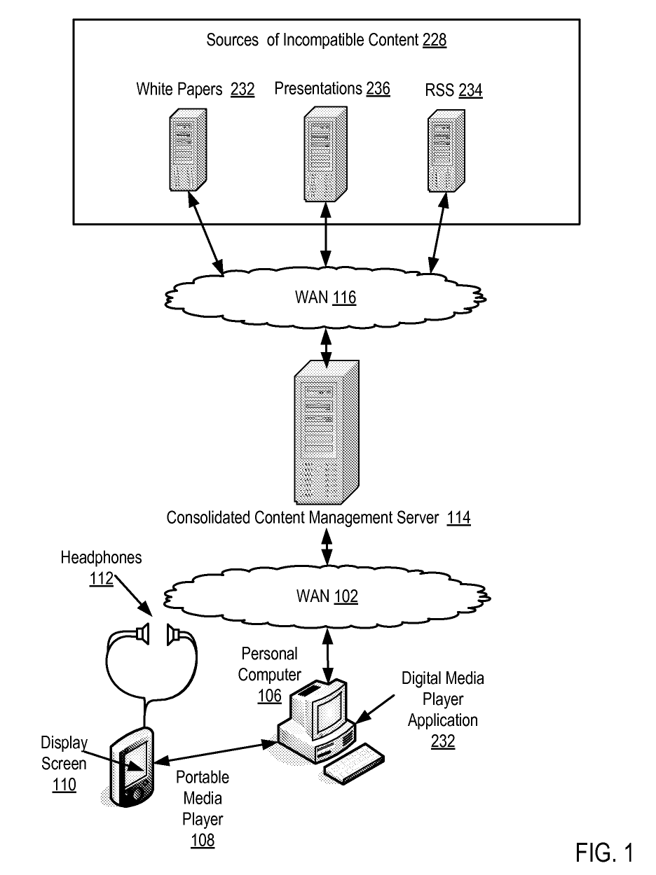

Exemplary methods, systems, and products email administration for administering incompatible content for rendering on a display screen of a portable media player are described with reference to the accompanying drawings, beginning with FIG. 1. FIG. 1 sets forth a network diagram illustrating an exemplary system for administering incompatible content for rendering on a display screen of a portable media player according to embodiments of the present invention. The system of FIG. 1 is capable of administering incompatible content for rendering on a display screen of a portable media player by selecting content for visual display on a display screen of a portable media player; the content being in a data format incompatible with the portable media player; creating a plurality of image files including the content, the image files being in a data format compatible with the portable media player; and storing the plurality of image files as a playlist.

The system of FIG. 1 includes a consolidated content management server (114) coupled for data communications with a personal computer (106) through a wide area network (102) (‘WAN’). The consolidated content management server (114) of FIG. 1 includes computer program instructions capable of selecting content for visual display on a display screen of a portable media player. The content selected is in a data format incompatible with the portable media player.

The example of FIG. 1 includes sources of incompatible content (228) that include a source of white papers (232). A white paper is an article that typically states an organization's position or philosophy about a social, political, or other subject, or a not-too-detailed technical explanation of an architecture, framework, or product technology. Typically, a white paper explains the results, conclusions, or construction resulting from some organized committee or research collaboration or design and development effort. Such white papers are often available in electronic form in Portable Document Format (.pdf) readable with Adobe® Acrobat, word processing documents readable with Microsoft Word, and many others as will occur to those of skill in the art. Whitepapers are typically not available in data formats supported by display screens of portable media players.

The example of FIG. 1 includes sources of incompatible content (228) that include a source of presentations (236). A presentation is typically created with presentation software (sometimes called “presentation graphics”), a category of application program used to create sequences of words and pictures that tell a story or help support a speech or public presentation of information. Presentation software can be divided into business presentation software and more general multimedia authoring tools, with some products having characteristics of both. Examples of presentation software include Microsoft's Powerpoint and Lotus's Freelance Graphics, Adobe Persuasion, Astound, Asymetrix Compel, Corel Presentations, and Harvard Graphics.

The example of FIG. 1 includes sources of incompatible content (228) that include a source of RSS content (234). RSS is a family of XML file formats for web syndication used by news websites and weblogs. The abbreviation is used to refer to the following standards: Rich Site Summary (RSS 0.91), RDF Site Summary (RSS 0.9, 1.0 and 1.1), and Really Simple Syndication (RSS 2.0). The RSS formats provide web content or summaries of web content together with links to the full versions of the content, and other meta-data. This content is typically delivered as an XML file called RSS feed, webfeed, RSS stream, or RSS channel.

The sources of incompatible content (228) of FIG. 1 are for explanation and not for limitation. In fact, portable media players typically support relatively few data formats, and therefore, incompatible content may be received from many disparate data sources as will occur to those of skill in the art.

The consolidated content management server (114) of FIG. 1 is also capable of creating a plurality of image files including the content and storing the plurality of image files as a playlist. The image files are created in a data format compatible with the portable media player. Typical portable media players having display screens capable of displaying image files support a limited number of image file formats. For example, the iPod® from Apple supports Joint Pictures Expert Group (‘JPEG’) and Portable Network Graphics (‘PNG’) file formats.

The consolidated content management server (114) of FIG. 1 is coupled for data communications with a personal computer (106) having installed upon it a digital media player application (232). A digital media player application (2324) is an application that manages media content such as audio files and video files. Such digital media player applications are typically capable of transferring image files to a portable media player. Examples of digital media player applications include Music Match™, iTunes®, and others as will occur to those of skill in the art.

The digital media player application (232) is capable of receiving the playlist from the consolidated content management server (114) and storing the playlist on the portable media player (108). The portable media player (108) of FIG. 1 is capable of displaying the plurality of images of the playlist on the display screen (110). Examples of portable media players include the iPod® from Apple and Creative Zen Vision from Creative labs.

Displaying the plurality of images of the playlist on the display screen advantageously allows a user to make use of content of incompatible data formats in a user-friendly manner. A presentation originally provided by a source of presentation in Microsoft Power Point may advantageously be viewed as a series of images in a playlist on an Apple iPod that does not support PowerPoint.

In the example of FIG. 1, the consolidated content management server (114) of FIG. 1 administers the incompatible content for rendering on a display screen of a portable media player according to the present invention. This is for explanation, and not for limitation. In fact, systems for administering incompatible content for rendering on a display screen of a portable media player according to the present invention may be implemented in less distributed environments. The data sources of incompatible content, and modules for administering incompatible content for rendering on a display screen of a portable media player, and the digital media player application for storing the playlist on a portable media player may reside in a single computer, or in distributed environment of any varying scope.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

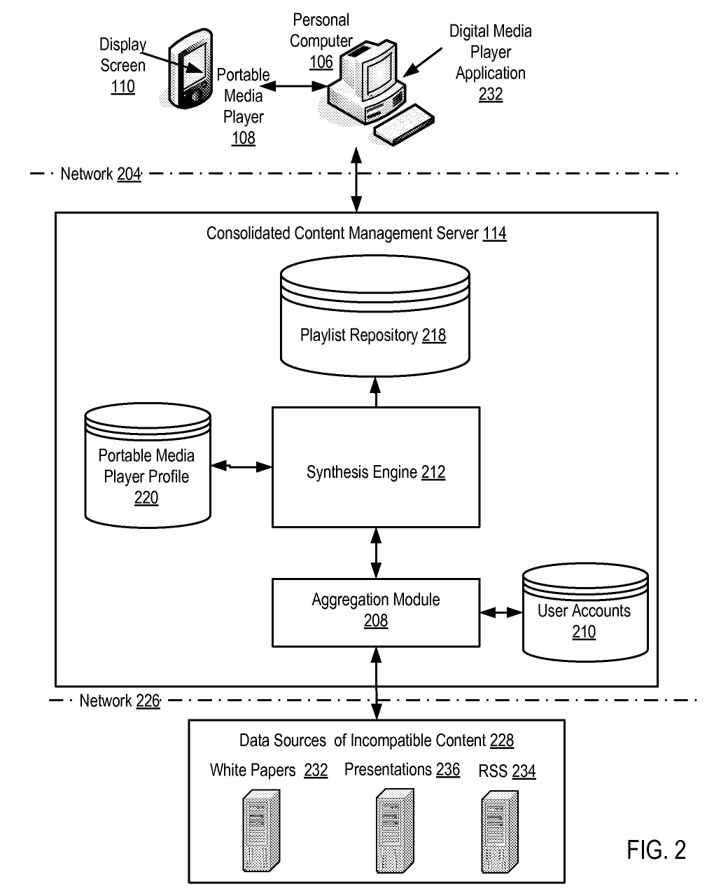

For further explanation, FIG. 2 sets forth a block diagram depicting a system for administering incompatible content for rendering on a display screen of a portable media player (108) according to the present invention. The system of FIG. 2 includes a portable media player (108) capable of displaying a plurality of images stored as a playlist on the integrated display screen (110). In the example of FIG. 2, a digital media player application (232) is capable of receiving images stored as playlists from a playlist repository (218) of a consolidated content management server (114) and storing the playlist on the portable media player (108).

The consolidated content management server (114) of FIG. 2 is capable of administering incompatible content for rendering on a display screen of a portable media player by selecting content for visual display on a display screen of a portable media player; the content being in a data format incompatible with the portable media player; creating a plurality of image files including the content, the image files being in a data format compatible with the portable media player; and storing the plurality of image files as a playlist.

The consolidated content management server (114) of FIG. 2 includes an aggregation module (208). The aggregation module (208) of FIG. 2 is implemented as computer program instructions for selecting content for visual display on a display screen of a portable media player. The exemplary aggregation module (208) is capable generally of selecting content for visual display on a display screen of a portable media player in accordance with an associated user account. Such a user account typically includes user information such as a user ID and identifications of sources of incompatible content (228) identified by a user to be rendered on the portable media player (108).

The consolidated content management server (114) of FIG. 2 includes a synthesis engine (212). The synthesis engine of FIG. 2 is implemented as computer program instructions for creating a plurality of image files including the content and storing the plurality of image files as a playlist. The image files are created in a data format compatible with the portable media player (108). The synthesis engine (212) of Figure creates a plurality of image files in a data format identified in a portable media player profile (220) maintained by the consolidated content management server (114). Portable media player profiles typically include an identification of the target portable media player and an identification of one or more image file formats that the target portable media player supports.

The consolidated content management server (114) includes repository (218) of playlists for rendering on the portable media player (108). Maintaining a repository (218) of playlists provides a single point of access at the consolidated content management server for content derived from incompatable data formats now capable of rendering as images on the display screen of the portable media player.

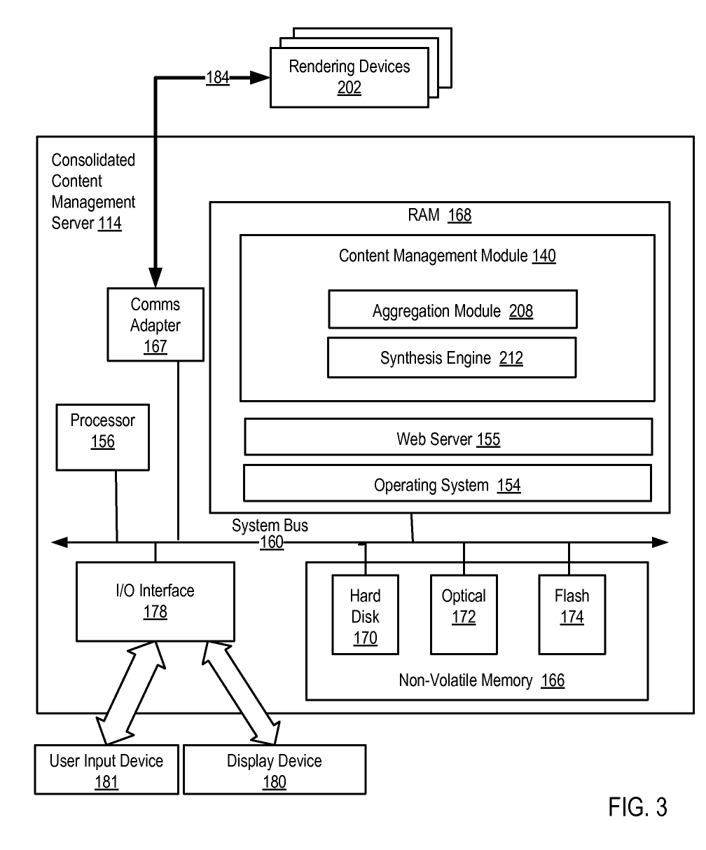

Administering incompatible content for rendering on a display screen of a portable media player in accordance with the present invention is generally implemented with computers, that is, with automated computing machinery. In the systems of FIGS. 1 and 2, for example, all the nodes, servers, and communications devices are implemented to some extent at least as computers. For further explanation, therefore, FIG. 3 sets forth a block diagram of automated computing machinery comprising an exemplary consolidated content management server (114) useful in administering incompatible content for rendering on a display screen of a portable media player according to embodiments of the present invention. The consolidated content management server (114) of FIG. 3 includes at least one computer processor (156) or ‘CPU’ as well as random access memory (168) (‘RAM’) which is connected through a system bus (160) to a processor (156) and to other components of the consolidated content management server (114).

Stored in RAM (168) is an exemplary consolidated content management module (140), computer program instructions for administering incompatible content for rendering on a display screen of a portable media player. The consolidated content management module (140) of FIG. 3 includes an aggregation module (208), computer program instructions for selecting content for visual display on a display screen of a portable media player. The exemplary aggregation module (208) is capable generally of selecting content for visual display on a display screen of a portable media player in accordance with an associated user account.

The consolidated content management module (140) of FIG. 3 also includes a synthesis engine (212) computer program instructions for creating a plurality of image files including the content and storing the plurality of image files as a playlist. The image files are created in a data format compatible with the portable media player (108) upon which the image files are to displayed. The synthesis engine (212) of FIG. 3 is capable of creating a plurality of image files in a data format identified in a portable media player profile (220) maintained by the consolidated content management server (114).

The exemplary consolidated content management server (114) of FIG. 3 also includes a web server (155). The consolidated content management server may usefully provide playlists of images created from incompatible content through the use of programs that run on a web server and build web pages, such as for example, servlets. Such programs may build dynamic server pages such as for example Java Server Pages (‘JSP’). One such web server useful in administering incompatible content for rendering on a display screen of a portable media player according to the present invention is the WebSphere® Application Server available from IBM. WebSphere Application Server is a Java™-based application platform, integrating enterprise data and transactions for the dynamic e-business. WebSphere Application Server delivers a rich application deployment environment with application services that provide transaction management, security, performance, availability, connectivity, and scalability.

Also stored in RAM (168) is an operating system (154). Operating systems useful in computers according to embodiments of the present invention include UNIX™, Linux™, Microsoft Windows NT™, AIX™, IBM's i5/OS™, and others as will occur to those of skill in the art.

The exemplary consolidated content management server (114) of FIG. 3 includes non-volatile computer memory (166) coupled through a system bus (160) to a processor (156) and to other components of the consolidated content management server (114). Non-volatile computer memory (166) may be implemented as a hard disk drive (170), an optical disk drive (172), an electrically erasable programmable read-only memory space (so-called ‘EEPROM’ or ‘Flash’ memory) (174), RAM drives (not shown), or as any other kind of computer memory as will occur to those of skill in the art.

The exemplary consolidated content management server (114) of FIG. 3 includes one or more input/output interface adapters (1 78). Input/output interface adapters in computers implement user-oriented input/output through, for example, software drivers and computer hardware for controlling output to display devices (180) such as computer display screens, as well as user input from user input devices (181) such as keyboards and mice.

The exemplary consolidated content management server (114) of FIG. 3 includes a communications adapter (167) for implementing data communications (184) with rendering devices (202). Such data communications may be carried out serially through RS-232 connections, through external buses such as a USB, through data communications networks such as IP networks, and in other ways as will occur to those of skill in the art. Communications adapters implement the hardware level of data communications through which one computer sends data communications to another computer, directly or through a network. Examples of communications adapters useful for administering incompatible content for rendering on a display screen of a portable media player include modems for wired dial-up communications, Ethernet (IEEE 802.3) adapters for wired network communications, 802.11b adapters for wireless network communications, and other as will occur to those of skill in the art.

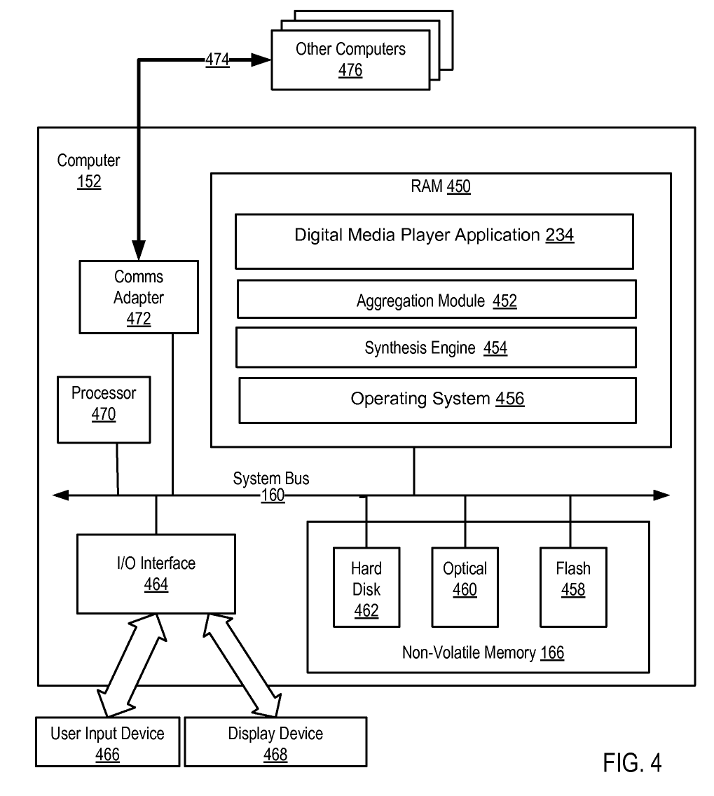

As discussed above, to display the images stored as a playlist on a portable media player, the playlist of images typically must be stored on the portable media player. A digital media player application running on a personal computer may be used to manage content for delivery to portable media players. For further explanation, therefore, FIG. 4 sets a block diagram of automated computing machinery comprising an exemplary computer (152) useful in administering incompatible content for rendering on a display screen of a portable media player according to the present invention. The computer (152) of FIG. 4 includes at least one computer processor (470) or ‘CPU’ as well as random access memory (450) (‘RAM’) which is connected through a system bus (160) to processor (470) and to other components of the computer.

Stored in RAM (450) is an operating system (456). Operating systems useful in computers according to embodiments of the present invention include UNIX™, Linux™, Microsoft XP™, AIX™, IBM's i5/OS™, and others as will occur to those of skill in the art.

Also stored in RAM (450) is a digital media player application (234). A digital media player application (234) is an application that manages media content such as audio files and video files. Such digital media player applications are typically capable of transferring media files to a portable media player. Examples of digital media player applications include Music Match™, iTunes®, and others as will occur to those of skill in the art. The digital media player application (234) of FIG. 4 is capable of storing a playlist of images created from incompatible content onto a portable media player.

As discussed above, administering incompatible content for rendering on a display screen of a portable media player according to the present invention is not limited to the distributed environments depicted in the examples of FIGS. 1 and 2. In fact, administering incompatible content for rendering on a display screen of a portable media player may be usefully carried out using a single computer. In the example of FIG. 4, therefore, also stored in RAM is an aggregation module (452) computer program instructions for selecting content for visual display on a display screen of a portable media player. The exemplary aggregation module (452) is capable generally of selecting content for visual display on a display screen of a portable media player in accordance with an associated user account.

Also stored in RAM is a synthesis engine (454) computer program instructions for creating a plurality of image files including the content and storing the plurality of image files as a playlist. The image files are created in a data format compatible with the portable media player upon which the image files are to displayed.

The operating system (456), digital media player application (234), aggregation module (452), and synthesis engine (454) in the example of FIG. 4 are shown in RAM (450), but many components of such software may be stored in non-volatile memory (166) also.

Computer (152) of FIG. 4 includes non-volatile computer memory (166) coupled through a system bus (160) to processor (470) and to other components of the computer (152). Non-volatile computer memory (166) may be implemented as a hard disk drive (462), optical disk drive (460), electrically erasable programmable read-only memory space (so-called ‘EEPROM’ or ‘Flash’ memory) (458), RAM drives (not shown), or as any other kind of computer memory as will occur to those of skill in the art.

The example computer of FIG. 4 includes one or more input/output interface adapters (464). Input/output interface adapters in computers implement user-oriented input/output through, for example, software drivers and computer hardware for controlling output to display devices (468) such as computer display screens, as well as user input from user input devices (466) such as keyboards and mice.

The exemplary computer (152) of FIG. 4 includes a communications adapter (472) for implementing data communications (474) with other computers (476). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for administering incompatible content for rendering on a display screen of a portable media player according to embodiments of the present invention include modems for wired dial-up communications, Ethernet (IEEE 802.3) adapters for wired network communications, and 802.11b adapters for wireless network communications.

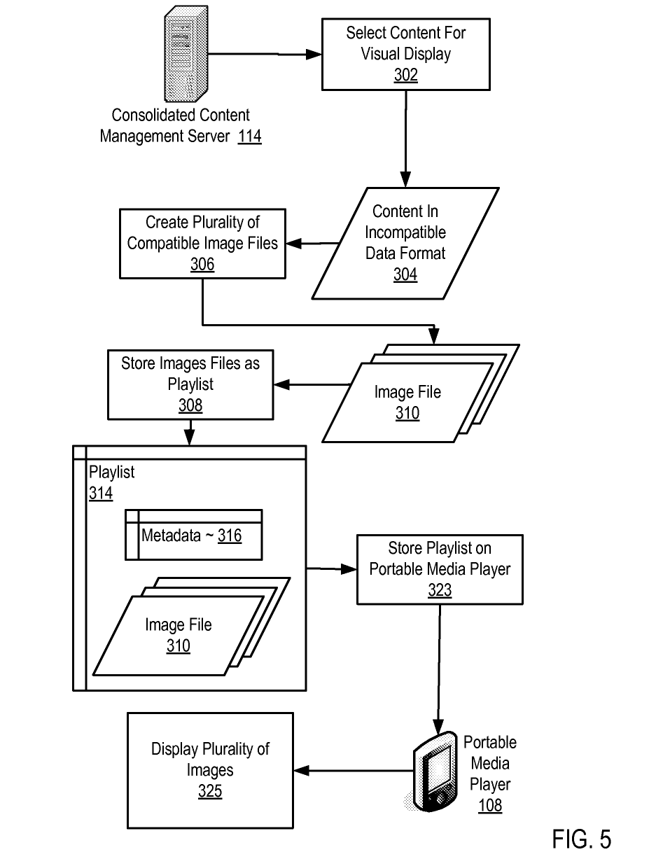

For further explanation, FIG. 5 sets forth a flow chart illustrating an exemplary computer computer-implemented method for administering content for rendering on a display screen of a portable media player. The method of FIG. 5 includes selecting (302) content for visual display on a display screen of a portable media player (108). As discussed above, the content is a data format incompatible with the portable media player (108). Selecting (302) content for visual display on a display screen of a portable media player (108) may be carried out in dependence upon a user account. Such a user account may include identifications of sources of incompatible content such as network addresses pointing to sources of white papers, presentations, markup documents such as RSS web pages, word processing documents, spreadsheets, and so on as will occur to those of skill in the art.

The method of FIG. 5 also includes creating (306) a plurality of image files (310) including the content (304), the image files (310) being in a data format compatible with the portable media player (108). Creating (306) a plurality of image files (310) including the content (304) may be carried out through the use of document conversion software. Such document conversion software is capable of receiving content in one data format and creating another data format containing the same content. One example of such document conversion software is Universal Document Converter. The Universal Document Converter is a virtual printer software that saves documents as image files. Universal Document Converter supports creating PDF, TIFF, JPEG or PNG image files from incompatible Hypertext Markup Language (‘HTML’) files, Adobe PDF files, Microsoft Word documents, Microsoft PowerPoint presentations or Autodesk AutoCAD drawings.

Creating (306) a plurality of image files (310) including the content (304) may be carried out through the use of document conversion software that is data format specific. For example, the XLS to Image(Jpeg/Jpg/Tiff/Bmp/Eps/Ps) Converter V2.0 is designed to convert Excel XLS document to image files. PPT to Image(Jpeg/Jpg/Tiff/Bmp/Eps/Ps) Converter V2.0 is another example of format-specfici document conversion software designed to covert a PowerPoint PPT presentation to an image file. DOC to Image(Jpeg/Jpg/Tiff/Bmp/Eps/Ps) Converter V2.0 is sitll another example of documents conversion software designed to covert a .doc word processing document to an image file.

The method of FIG. 5 also includes storing (308) the plurality of image files (310) as a playlist (314). Storing (308) the plurality of image files (310) as a playlist (314) may be carried out by naming the image files and associating the names of the image files with a playlist also typically having a name. The names of the image files may be associated with the playlist through the use of a metadata file, such as an eXtensible Markup Language (‘XML file’). iTunes® from Apple®, for example, supports an XML library file containing metadata describing the content managed by iTunes. In iTunes, for example, image file names may be associated with one or more playlists through the XML library file.

The method of FIG. 5 also includes storing (323) the playlist (314) on the portable media player (108). Storing (323) the playlist (314) on the portable media player (108) may be carried out by copying individual image files of the playlist and the associated metadata onto the portable media player. Storing (323) the playlist (314) on the portable media player (108) may be carried out through the use of digital media player application such as, for example, iTunes®, MusicMatch™, Windows Media Player®, and others as will occur to those of skill in the art.

The method of FIG. 5 also includes displaying (325) the plurality of images (310) of the playlist (314) on the display screen of the portable media player (108). Displaying (325) the plurality of images (310) of the playlist (314) on the display screen of the portable media player (108) advantageously allows otherwise incompatible content to be rendered on the digital media player thereby expanding the content available for rendering on the portable media player.

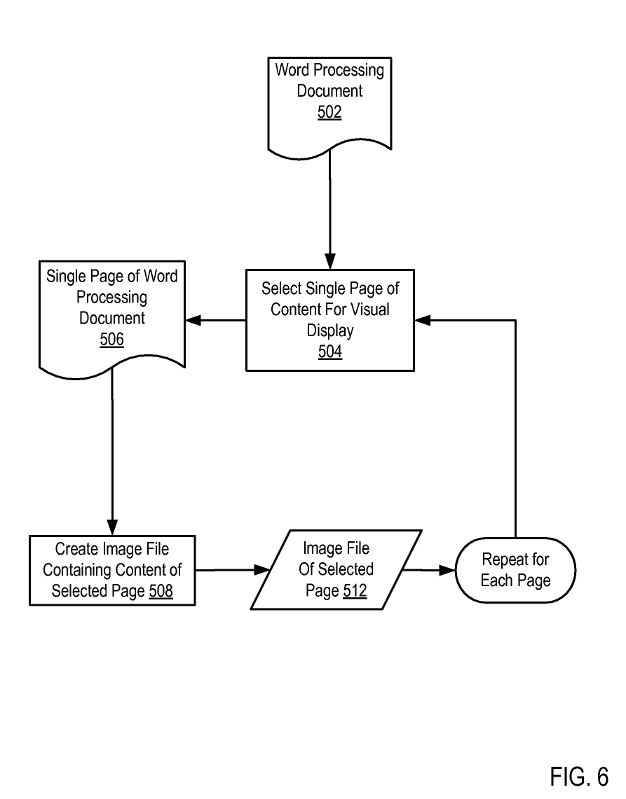

As discussed above, one incompatible data format capable of being administered for rendering on a display screen of a portable media player includes word processing documents. For further explanation, therefore, FIG. 6 sets forth a method of selecting content in a word processing document for visual display on a display screen of a portable media player and creating a plurality of image files that contains the content. In the method of FIG. 6, selecting content for visual display on a display screen of a portable media player and creating a plurality of image files that contains the content is carried out by repeatedly, for each page of the word processing document, selecting (504) a single page of content (506) contained in a word processing document (502) and creating (508) an image file (512) containing the selected page of content (506). As discussed above, creating (508) an image file (512) containing the selected page of content (506) may be carried out through the use of document conversion software such as the Universal Document Converter. DOC to Image (Jpeg/Jpg/Tiff/Bmp/Eps/Ps) Converter V2.0 is another example of documents conversion software designed to covert a .doc word processing document to a JPEG image. Creating a single image for each page in the word processing document allows the contents of each page of the document to be displayed on the display screen of the portable media player thereby replicating the content of the word processing document page by page.

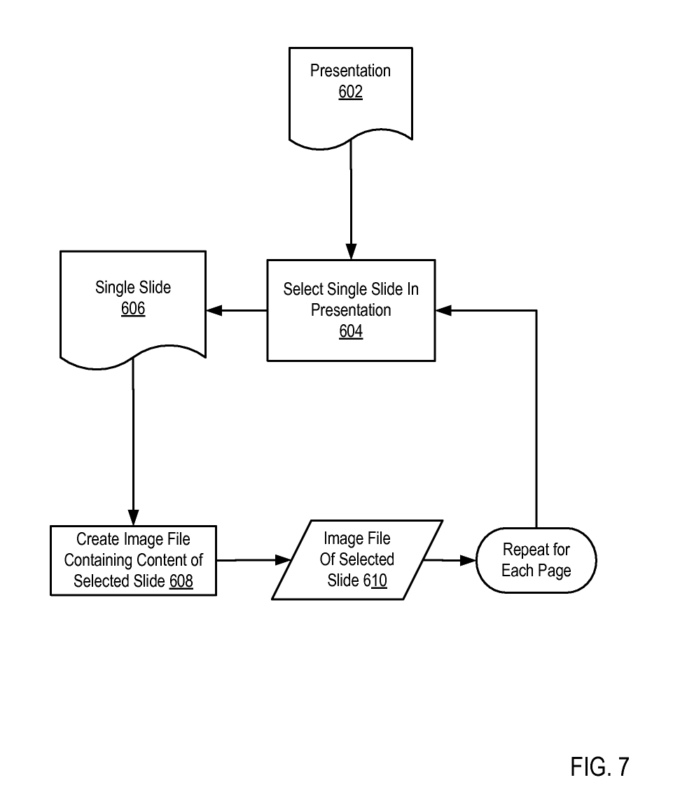

As discussed above, one incompatible data format capable of being administered for rendering on a display screen of a portable media player includes presentations, such as, Microsoft Power Point® presentations. For further explanation, therefore, FIG. 7 sets forth a flow chart illustrating an exemplary method for selecting content in a presentation for visual display on a display screen of a portable media player and creating a plurality of image files containing the content. In the method of FIG. 7, selecting content in a presentation for visual display on a display screen of a portable media player and creating a plurality of image files containing the content is carried out by repeatedly, for each slide of the presentation, selecting (604) a single slide (606) of content contained in a presentation (602) and creating (608) an image file (610) containing the selected slide (606) of content. As discussed above, creating (608) an image file (610) containing the selected slide (606) of content may be carried out through the use of document conversion software such as the Universal Document Converter. PPT to Image (Jpeg/Jpg/Tiff/Bmp/Eps/Ps) Converter V2.0 is another example of documents conversion software designed to covert a PowerPoint PPT presentation to a JPEG image. Creating a single image for each slide of the presentation allows the contents of each slide to be individually displayed on the display screen of the portable media player thereby replicating the content of the presentation page by page.

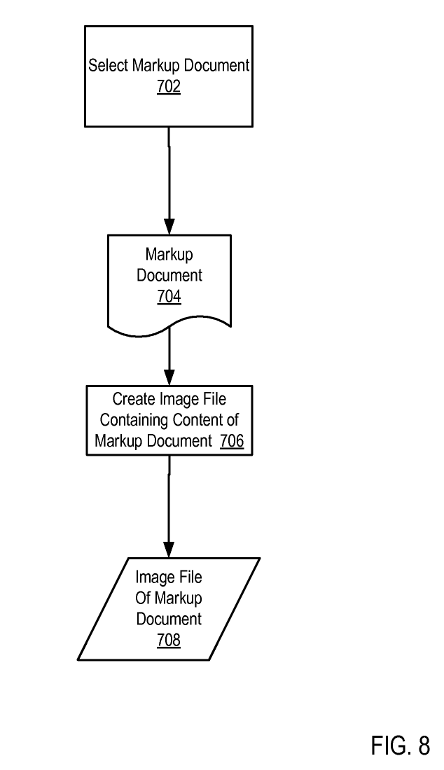

As discussed above, one incompatible data format capable of being administered for rendering on a display screen of a portable media player includes markup documents, such as, for example, RSS web pages. For further explanation, therefore, FIG. 8 sets forth a flow chart illustrating an exemplary method for selecting content in a markup document for visual display on a display screen of a portable media player and creating a plurality of image files containing the content of the markup document. In the method of FIG. 8, selecting content in a markup document for visual display on a display screen of a portable media player and creating a plurality of image files containing the content of the markup document is carried out by selecting (702) a markup document (704) and creating (706) an image file (708) containing the content of the markup document (704). As discussed above, creating (706) an image file (708) containing the content of the markup document (704) may be carried out through the use of document conversion software such as the Universal Document Converter.

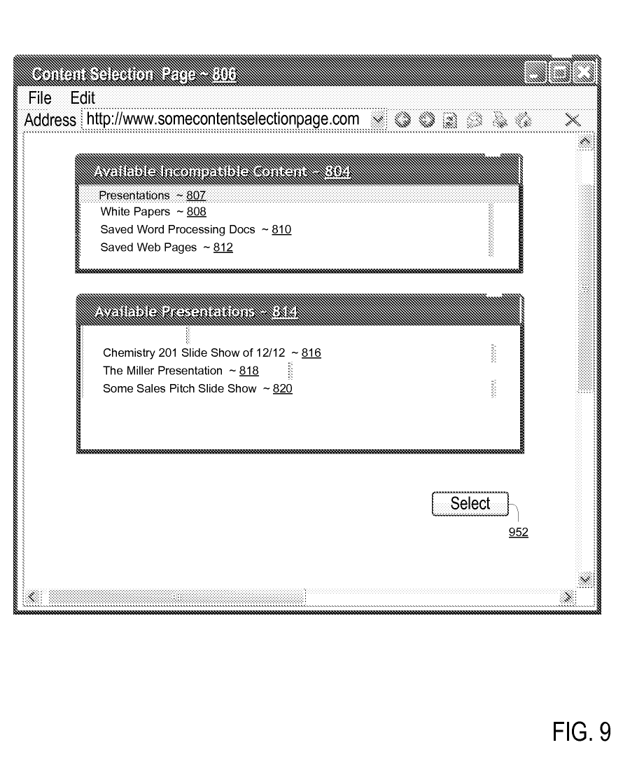

As discussed above, selecting content for visual display on a display screen of a portable media player may be carried out in dependence upon content identified by a user and identifications of the sources of such content in a user account. For further explanation, therefore, FIG. 9 sets forth a line drawing of an exemplary content selection screen useful in receiving from a user an identification of content for visual display on a display screen of a portable media player according to the present invention. The exemplary content selection screen (806) of FIG. 9 is capable of providing to a user identifications of available content. The exemplary content selection screen (806) includes an available content (804) Graphical User Interface (‘GUI’) widget displaying a selection of incompatible content in incompatible data formats available for administration for rendering on a display screen of a portable media player according to the present invention. In the example of FIG. 9, the incompatible content available for administration for rendering on a display screen of a portable media player according to the present invention include presentations (807), white papers (808), saved word processing document (810), and saved web pages (812).

In the example of FIG. 9, the content selection screen (806) also includes a second widget displaying available content associated with the highlighted content. In the example of FIG. 9, available presentations (814) are displaying in response to highlighting the available incompatible content of presentations (807). In the example of FIG. 9, available presentations include a ‘Chemistry 201 Slide Show of December 12’ (816), ‘The Miller Presentation’ (818), and a presentation entitled ‘Some Sales Pitch Slide Show’ (820). Using the select (952) GUI button a user is empowered to select available incompatible content for rendering on a display screen of a portable media player according to the present invention.

The exemplary incompatible content and available presentations of the example of FIG. 9 are presented for explanation and not for limitation. In fact, incompatible content in incompatible data formats not depicted or described herein will occur to those of skill in the art and such content may be usefully administered for rendering on a display screen of a portable media player according to the present invention

Exemplary embodiments of the present invention are described largely in the context of a fully functional computer system for administering incompatible content for rendering on a display screen of a portable media player. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer-implemented method for administering incompatible content for rendering on a display screen of a portable media player, the method comprising:
selecting content for visual display on a display screen of a portable media player, the content being in a data format incompatible with the portable media player;
creating a plurality of image files including the content, the image files being in a data format compatible with the portable media player; and
storing the plurality of image files as a playlist.

2. The method of claim 1 further comprising:
storing the playlist on the portable media player; and
displaying the plurality of images of the playlist on the display screen of the portable media player.

3. The method of claim 1 wherein:
selecting content for visual display on a display screen of a portable media player further comprises selecting a single page of content contained in a word processing document; and
creating a plurality of image files further comprises creating an image file containing the selected page of content.

4. The method of claim 1 wherein:
selecting content for visual display on a display screen of a portable media player further comprises selecting a single slide of content contained in a presentation; and
creating a plurality of image files further comprises creating an image file containing the selected slide of content.

5. The method of claim 1 wherein:
selecting content for visual display on a display screen of a portable media player further comprises selecting a markup document; and
creating a plurality of image files further comprises creating an image file containing the content of the markup document.

6. The method of claim 1 wherein selecting content for visual display on a display screen of a portable media player further comprises:
providing to a user identifications of available content; and
receiving from the user an identification of the selected content.

7. A system for administering incompatible content for rendering on a display screen of a portable media player, the system comprising:
a computer processor;
a computer memory operatively coupled to the computer processor;
the computer memory having disposed within it computer program instructions capable of:
selecting content for visual display on a display screen of a portable media player, the content being in a data format incompatible with the portable media player;
creating a plurality of image files including the content, the image files being in a data format compatible with the portable media player; and
storing the plurality of image files as a playlist.

8. The system of claim 7 wherein the computer memory also has disposed within it computer program instructions capable of:
storing the playlist on the portable media player; and
displaying the plurality of images of the playlist on the display screen of the portable media player.

9. The system of claim 7 wherein:
the computer program instructions capable of selecting content for visual display on a display screen of a portable media player further comprise computer program instructions capable of selecting a single page of content contained in a word processing document; and
the computer program instructions capable of creating a plurality of image files further comprise computer program instructions capable of creating an image file containing the selected page of content.

10. The system of claim 7 wherein:
the computer program instructions capable of selecting content for visual display on a display screen of a portable media player further comprise computer program instructions capable of selecting a single slide of content contained in a presentation; and
the computer program instructions capable of creating a plurality of image files further comprise computer program instructions capable of creating an image file containing the selected slide of content.

11. The system of claim 7 wherein:
computer program instructions capable of selecting content for visual display on a display screen of a portable media player further comprise selecting a markup document; and
computer program instructions capable of creating a plurality of image files further comprise creating an image file containing the content of the markup document.

12. The system of claim 7 wherein the computer program instructions capable of selecting content for visual display on a display screen of a portable media player further comprise computer program instructions capable of:
providing to a user identifications of available content; and
receiving from the user an identification of the selected content.

13. A computer program product for administering incompatible content for rendering on a display screen of a portable media player, the computer program product embodied on a computer-readable medium, the computer program product comprising:
computer program instructions for selecting content for visual display on a display screen of a portable media player, the content being in a data format incompatible with the portable media player;
computer program instructions for creating a plurality of image files including the content, the image files being in a data format compatible with the portable media player; and
computer program instructions for storing the plurality of image files as a playlist.

14. The computer program product of claim 13 further comprising:
computer program instructions for storing the playlist on the portable media player; and
computer program instructions for displaying the plurality of images of the playlist on the display screen of the portable media player.

15. The computer program product of claim 13 wherein:
the computer program instructions for selecting content for visual display on a display screen of a portable media player further comprise computer program instructions for selecting a single page of content contained in a word processing document; and
the computer program instructions for creating a plurality of image files further comprise computer program instructions for creating an image file containing the selected page of content.

16. The computer program product of claim 13 wherein:
the computer program instructions for selecting content for visual display on a display screen of a portable media player further comprise computer program instructions for selecting a single slide of content contained in a presentation; and
the computer program instructions for creating a plurality of image files further comprise computer program instructions for creating an image file containing the selected slide of content.

17. The computer program product of claim 13 wherein:
the computer program instructions for selecting content for visual display on a display screen of a portable media player further comprise computer program instructions for selecting a markup document; and
thje computer program instructions for creating a plurality of image files further comprise computer program instructions for creating an image file containing the content of the markup document.

18. The computer program product of claim 13 wherein the computer program instructions for selecting content for visual display on a display screen of a portable media player further comprise:
computer program instructions for providing to a user identifications of available content; and
computer program instructions for receiving from the user an identification of the selected content.

19. The computer program product of claim 13 wherein the computer-readable medium further comprises a recording medium.

20. The computer program product of claim 13 wherein the computer-readable medium further comprises a transmission medium.
